(19) United States
(12) Patent Application Publication
(10) Pub. No.: US 2024/0386834 A1
(43) Pub. Date: Nov. 21, 2024

(54) METHOD AND APPARATUS FOR COMPENSATING FOR BRIGHTNESS OF DISPLAY PANEL, AND DEVICE

(71) Applicant: HUAWEI TECHNOLOGIES CO., LTD., Shenzhen (CN)

(72) Inventors: Mei YANG, Shenzhen (CN); Jun LIU, Shenzhen (CN); Yang LIU, Shenzhen (CN); Yang LU, Chengdu (CN); Yuhan YAN, Shenzhen (CN); Xiaopeng CHEN, Shenzhen (CN)

(21) Appl. No.: 18/785,373

(22) Filed: Jul. 26, 2024

Related U.S. Application Data
(63) Continuation of application No. PCT/CN2022/074822, filed on Jan. 28, 2022.

(51) Int. Cl. G09G 3/20

(52) U.S. Cl. CPC G09G 3/2074; G09G 3/2092; G09G 2310/061; G09G 2310/08; G09G 2320/0233

(57) ABSTRACT

A method (200) and an apparatus (500) for compensating for brightness of a display panel (140), and a display device (100) are provided. The method (200) for compensating for brightness of a display panel (140) includes: timing a vertical blanking interval (Vblank) in a current frame on the display panel (140) (202); and determining, in response to that a timing time of the vertical blanking interval (Vblank) reaches a first threshold time, a first value used to perform first compensation on brightness of the display panel (140) during the vertical blanking interval (Vblank) in the current frame (204). According to the method (200) for compensating for brightness of a display panel (140), a brightness change caused by current leakage can be compensated for by adjusting a related analog voltage in a timely manner.

### CROSS-REFERENCE TO RELATED APPLICATION

This application is a continuation of International Application No. PCT/CN2022/074822, filed on Jan. 28, 2022, the disclosure of which is hereby incorporated by reference in its entirety.

### TECHNICAL FIELD

Embodiments of this disclosure generally relate to the field of display technologies, and more specifically, to a method and an apparatus for compensating for brightness of a display panel, and a device.

### BACKGROUND

In recent years, with continuous improvement of resolution and a refresh rate of a display panel, a higher requirement is imposed on a rendering capability of a graphics card. When a rendering frame rate of the graphics card is inconsistent with the refresh rate of the display panel, problems such as frame freezing, tearing, and a delay occur. In view of this, graphics card manufacturers gradually put forward a variable refresh rate (VRR) technology. In the VRR technology, the refresh rate of the display panel is dynamically adjusted to match the rendering frame rate of the graphics card, so as to resolve problems such as a picture delay and frame freezing caused by vertical synchronization when the rendering frame rate of the graphics card is less than the refresh rate of the display panel.

In the VRR technology, duration of a vertical active interval (Vactive) is fixed, and duration of a vertical blanking interval (Vblank) is variable. The refresh rate of the display panel is adjusted by adjusting the duration of the vertical blanking interval. In an example of a liquid crystal display (LCD) panel, a charging time of each row of pixel capacitors at a low refresh rate is the same as a charging time of each row of pixel capacitors at a high refresh rate. That is, at different refresh rates, when a thin film transistor (TFT) is just turned off, there is a consistent pixel voltage at two ends of a liquid crystal, and therefore consistent brightness is achieved. However, after the TFT is turned off, the duration of the vertical blanking interval at the low refresh rate is longer. Therefore, a holding time of a voltage of the pixel capacitor is longer than that at the high refresh rate. However, a longer holding time indicates severer current leakage of the pixel capacitor, resulting in a decrease in a voltage at two ends of a liquid crystal capacitor, and lower brightness than that at the high refresh rate. Therefore, when the refresh rate of the display panel changes, a still picture is displayed between high brightness and low brightness due to current leakage of the capacitor. When a relative value of a brightness change exceeds 1% of a Weber's constant, human eyes can feel a noticeable flicker.

Therefore, the VRR technology poses a new challenge to the display panel: The display panel needs to have high display consistency within a predetermined refresh rate change range. Currently, most display panels have a problem of picture flickering when the refresh rate is dynamically adjusted. Such picture flickering makes a user feel visual jitter and fatigue, affecting user experience.

### SUMMARY

In view of the foregoing problem, embodiments of this disclosure are intended to provide a solution for compensating for brightness of a display panel.

According to a first aspect of this disclosure, a method for compensating for brightness of a display panel is provided. The method includes: timing a vertical blanking interval in a current frame on the display panel; and determining, in response to that a timing time of the vertical blanking interval reaches a first threshold time, a first value used to perform first compensation on brightness of the display panel during the vertical blanking interval in the current frame. A compensation value used to compensate for the brightness of the display panel during the vertical blanking interval in the current frame is determined in real time during the vertical blanking interval in the current frame, so that a brightness change caused by current leakage can be compensated for by adjusting a related analog voltage in a timely manner. Therefore, there is no delay between brightness compensation and current leakage, to fundamentally resolve picture flickering and improve user experience of the display panel.

In some implementations, the method further includes: determining, in response to that the timing time of the vertical blanking interval reaches a second threshold time, a second value used to perform second compensation on the brightness of the display panel during the vertical blanking interval in the current frame, where the second threshold time is greater than the first threshold time, and the second compensation is later than the first compensation. In this manner, the brightness of the display panel during the vertical blanking interval may be compensated for in a segment-based compensation manner, so that a brightness variation is further reduced, to ensure that the brightness variation is less than a threshold at which a flicker can be observed by human eyes.

In some implementations, the display panel includes a first subpixel of a first pixel unit, and the method further includes: determining a target grayscale value of the first subpixel in a next frame based on the timing time of the vertical blanking interval and an original grayscale value of the first subpixel in the next frame, where the next frame is located after the current frame in a display order, and the target grayscale value is used to compensate for brightness of the first subpixel during a vertical active interval in the next frame. In this manner, different grayscale values may be compensated for to different degrees during the vertical active interval in the next frame, so that a brightness difference and a chrominance difference between different refresh rates may be well compensated for, to resolve a flickering problem caused by the brightness difference and the chrominance difference.

In some implementations, the next frame closely follows the current frame in the display order, and the determining a target grayscale value includes: performing the following operations in response to that the timing time of the vertical blanking interval reaches a third threshold time: obtaining a first candidate grayscale value of the first subpixel for the third threshold time; obtaining a second candidate grayscale value of the first subpixel for a fourth threshold time, where the fourth threshold time is greater than the third threshold time; and determining the target grayscale value based on the first candidate grayscale value and the second candidate grayscale value in response to that duration of the vertical blanking interval is between the third threshold time and the fourth threshold time. In this manner, after the duration of the vertical blanking interval is accurately determined, that is, after a refresh rate of the current frame is accurately determined, different grayscale values may be compensated for to different degrees during the vertical active interval in the next frame based on the duration, so that a brightness difference and a chrominance difference between different refresh rates may be well compensated for, to resolve a flickering problem caused by the brightness difference and the chrominance difference.

In some implementations, the obtaining a first candidate grayscale value includes: determining a compensation grayscale value as the first candidate grayscale value based on the third threshold time and the original grayscale value, where the compensation grayscale value is used to compensate for the original grayscale value when the duration is equal to the third threshold time. In this manner, a compensation grayscale value that is used to compensate for the original grayscale value and that is used for a specific threshold time may be efficiently determined.

In some implementations, the obtaining a first candidate grayscale value includes: obtaining a polarity of the first subpixel based on a location of the first subpixel on the display panel; and determining a compensation grayscale value as the first candidate grayscale value based on the third threshold time, the original grayscale value, and the polarity of the first subpixel, where the compensation grayscale value is used to compensate for the original grayscale value when the duration is equal to the third threshold time. In this manner, a polarity difference between subpixels may be considered in brightness compensation during the vertical active interval in the next frame, so that targeted compensation may be provided for pixel capacitors of subpixels with different polarities, and a brightness difference between different regions on the display panel 140 may be more precisely compensated for based on analog compensation.

In some implementations, the determining the target grayscale value based on the first candidate grayscale value and the second candidate grayscale value includes: performing interpolation on the first candidate grayscale value and the second candidate grayscale value, to obtain the target grayscale value corresponding to the duration. In this manner, the target grayscale value for the refresh rate of the current frame may be accurately obtained, to improve effect of digital compensation.

In some implementations, the third threshold time is equal to the first threshold time, and the fourth threshold time is equal to the second threshold time.

In some implementations, the determining a target grayscale value includes: obtaining a scaling factor for the original grayscale value of the first subpixel based on a location of the first subpixel on the display panel; and scaling the original grayscale value based on the scaling factor, to determine the target grayscale value. In this manner, a difference between different locations on the display panel may be considered in brightness compensation during the vertical active interval in the next frame, so that a brightness difference between different regions on the display panel may be more precisely compensated for based on analog compensation.

In some implementations, the determining a first value includes: determining an analog compensation value as the first value by using the first threshold time, where the analog compensation value is used to compensate for the brightness of the display panel when the duration of the vertical blanking interval is equal to the first threshold time.

In some implementations, the timing a vertical blanking interval includes: timing a display control signal used for the display panel.

In some implementations, the display control signal includes at least one of the following: a horizontal synchronization HSYNC signal, a vertical synchronization VSYNC signal, or a data enable DE signal.

According to a second aspect of this disclosure, an electronic apparatus is provided. The electronic apparatus includes: a timing module, configured to time a vertical blanking interval in a current frame on a display panel; and a first value determining module, configured to determine, in response to that a timing time of the vertical blanking interval reaches a first threshold time, a first value used to perform first compensation on brightness of the display panel during the vertical blanking interval in the current frame. A compensation value used to compensate for the brightness of the display panel during the vertical blanking interval in the current frame is determined in real time during the vertical blanking interval in the current frame, so that a brightness change caused by current leakage can be compensated for by adjusting a related analog voltage in a timely manner. Therefore, there is no delay between brightness compensation and current leakage, to fundamentally resolve picture flickering and improve user experience of the display panel.

In some implementations, the electronic apparatus further includes a second value determining module, configured to determine, in response to that the timing time of the vertical blanking interval reaches a second threshold time, a second value used to perform second compensation on the brightness of the display panel during the vertical blanking interval in the current frame, where the second threshold time is greater than the first threshold time, and the second compensation is later than the first compensation. In this manner, the brightness of the display panel during the vertical blanking interval may be compensated for in a segment-based compensation manner, so that a brightness variation is further reduced, to ensure that the brightness variation is less than a threshold at which a flicker can be observed by human eyes.

In some implementations, the display panel includes a first subpixel of a first pixel unit, and the electronic apparatus further includes a target grayscale value determining module, configured to determine a target grayscale value of the first subpixel in a next frame based on the timing time of the vertical blanking interval and an original grayscale value of the first subpixel in the next frame, where the next frame is located after the current frame in a display order, and the target grayscale value is used to compensate for brightness of the first subpixel during a vertical active interval in the next frame. In this manner, different grayscale values may be compensated for to different degrees during the vertical active interval in the next frame, so that a brightness difference and a chrominance difference between different refresh rates may be well compensated for, to resolve a flickering problem caused by the brightness difference and the chrominance difference.

In some implementations, the next frame closely follows the current frame in the display order, and the target grayscale value determining module is further configured to perform the following operations in response to that the timing time of the vertical blanking interval reaches a third threshold time: obtaining a first candidate grayscale value of the first subpixel for the third threshold time; obtaining a second candidate grayscale value of the first subpixel for a fourth threshold time, where the fourth threshold time is greater than the third threshold time; and determining the target grayscale value based on the first candidate grayscale value and the second candidate grayscale value in response to that duration of the vertical blanking interval is between the third threshold time and the fourth threshold time. In this manner, after the duration of the vertical blanking interval is accurately determined, that is, after a refresh rate of the current frame is accurately determined, different grayscale values may be compensated for to different degrees during the vertical active interval in the next frame based on the duration, so that a brightness difference and a chrominance difference between different refresh rates may be well compensated for, to resolve a flickering problem caused by the brightness difference and the chrominance difference.

According to a third aspect of this disclosure, an electronic device is provided. The electronic device includes: the electronic apparatus according to the second aspect of this disclosure; and a drive circuit, configured to: receive a first value, and apply a drive signal to a display panel based on the first value. A compensation value used to compensate for brightness of the display panel during a vertical blanking interval in a current frame is determined in real time during the vertical blanking interval in the current frame, so that a brightness change caused by current leakage can be compensated for by adjusting a related analog voltage in a timely manner. Therefore, there is no delay between brightness compensation and current leakage, to fundamentally resolve picture flickering and improve user experience of the display panel.

In some implementations, the drive signal includes at least one of the following: an array common ACOM voltage signal or a shared common SVCM voltage signal. Current leakage may be compensated for in real time during the vertical blanking interval in the current frame by using the ACOM voltage signal and the SVCM voltage signal. Therefore, there is no delay between brightness compensation and current leakage, to fundamentally resolve picture flickering and improve user experience of the display panel.

The summary is provided to describe a selection of concepts in a simplified form. The concepts are further described in the following descriptions of embodiments. The summary is neither intended to identify key features or main features of this disclosure, nor intended to limit the scope of this disclosure.

### BRIEF DESCRIPTION OF DRAWINGS

The foregoing and other objectives, features, and advantages of embodiments of this disclosure become easy to understand by reading the following detailed descriptions with reference to the accompanying drawings. In the accompanying drawings, several embodiments of this disclosure are shown by way of example and not limitation.

FIG. 1 is a diagram of a display device according to some embodiments of this disclosure;

FIG. 2 is a flowchart of a method for compensating for brightness of a display panel according to some embodiments of this disclosure;

FIG. 3 is an example timing diagram for compensating for brightness of a display panel according to some embodiments of this disclosure;

FIG. 4 is a flowchart of a method for determining a target grayscale value according to some embodiments of this disclosure; and

FIG. 5 is a block diagram of an example apparatus for compensating for brightness of a display panel according to some embodiments of this disclosure.

### DESCRIPTION OF EMBODIMENTS

The following describes preferred embodiments of this disclosure in more detail with reference to the accompanying drawings. Although preferred embodiments of this disclosure are shown in the accompanying drawings, it should be understood that this disclosure may be implemented in various forms and should not be limited by embodiments described herein. Instead, these embodiments are provided to make this disclosure more thorough and complete and to fully convey the scope of this disclosure to a person skilled in the art.

The term “including” and variants thereof used in this specification indicate open inclusion, that is, “including but not limited to”. Unless otherwise stated, the term “or” means “and/or”. The term “based on” means “at least partially based on”. The terms “an example embodiment” and “an embodiment” mean “at least one example embodiment”. The term “another embodiment” means “at least one other embodiment”. Terms such as “upper”, “lower”, “front”, and “rear” that indicate a placement or location relationship are based on an orientation or a location relationship shown in the accompanying drawings, are merely used to describe a principle of this disclosure, and do not indicate or imply that a specified element needs to have a specific orientation or be constructed or operated in a specific orientation, and therefore cannot be understood as a limitation on this disclosure.

As described above, for a display panel to which a VRR technology is applied, duration of a vertical blanking interval changes due to different refresh rates. Therefore, brightness of the display panel changes, and a picture flicker that can be observed by human eyes may occur.

There are the following two conventional solutions for resolving flickering of a displayed picture: In a first solution, the refresh rate is detected in real time, brightness at a maximum refresh rate is used as a reference, and brightness of grayscales at different refresh rates is adjusted to the reference brightness through compensation. In a second solution, duration of a vertical blanking interval in a current frame period is obtained in real time, and a gamma voltage compensation value is delivered when the duration reaches a predetermined threshold.

However, the two conventional solutions each have a corresponding problem. For example, for the first solution, refresh rate detection is performed in a vertical blanking interval in a previous frame, while brightness compensation takes effect in a vertical active interval in a current frame. Therefore, there is a delay between current leakage and compensation, and picture flickering cannot be fundamentally resolved. In addition, in an extreme scenario in which the refresh rate is switched between a maximum value and a minimum value, a flickering degree may be increased.

For the second solution, because gamma voltage-based compensation takes effect only in a vertical active interval in a next frame, even if the gamma voltage compensation value is repeatedly delivered in the vertical blanking interval in the current frame, only a compensation value delivered last time takes effect in the vertical active interval in the next frame. That is, in the second solution, the brightness of the display panel cannot be compensated for in a timely manner in the vertical blanking interval in the current frame. Therefore, there is also a delay between current leakage and compensation, and picture flickering cannot be fundamentally resolved. In addition, in an extreme scenario in which the refresh rate is switched between a maximum value and a minimum value, a flickering degree may also be increased. Furthermore, because current leakage of a pixel capacitor is a slow process, compensation at an end of the vertical blanking interval in the second solution may aggravate flickering.

Embodiments of this disclosure provide a solution for compensating for brightness of a display panel. According to embodiments of this disclosure, a vertical blanking interval in a current frame is timed, and when a predetermined threshold time is reached, a corresponding compensation value is delivered to compensate for brightness of the display panel in a timely manner during the vertical blanking interval in the current frame.

It is understood from the following descriptions that in a solution according to embodiments of this disclosure, a compensation value used to compensate for the brightness of the display panel during the vertical blanking interval in the current frame is determined in real time during the vertical blanking interval in the current frame, so that a brightness change caused by current leakage can be compensated for by adjusting a related analog voltage in a timely manner. Therefore, there is no delay between brightness compensation and current leakage, to fundamentally resolve picture flickering and improve user experience of the display panel.

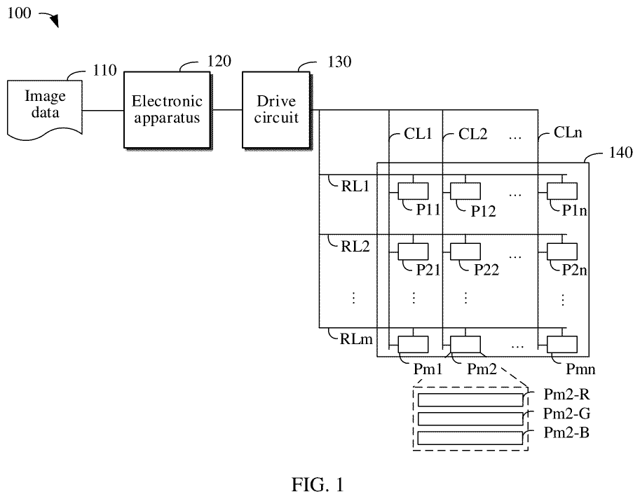

FIG. 1 is a diagram of a display device 100 according to some embodiments of this disclosure. The display device 100 may generally include an electronic apparatus 120, a drive circuit 130, and a display panel 140. It should be understood that the display device 100 may further include parts that are not shown and/or shown parts may be omitted. The scope of this disclosure is not limited in this aspect.

As shown in FIG. 1, the electronic apparatus 120 may receive image data 110 from an image source (not shown). In some embodiments, the image data 110 may be a video source signal. In some embodiments, the received image data 110 may be first processed by an image processor, for example, processing such as image enhancement and/or noise reduction is performed. The electronic apparatus 120 may generate, based on the received image data 110, a timing control signal for driving the drive circuit 130 of the display panel 140. In some embodiments, the electronic apparatus 120 may be implemented by one or more chips and/or hardware logic components. Example types of hardware logic components that may be used include but are not limited to a field programmable gate array (FPGA), an application-specific integrated circuit (ASIC), an application-specific standard part (ASSP), a system on chip (SoC), a complex programmable logic device (CPLD), and the like.

The drive circuit 130 generates, based on the received timing control signal, a drive signal for controlling the display panel 140. In some embodiments, the drive signal may include a gamma voltage signal. In some embodiments, the drive signal may include an array common (ACOM) voltage signal. For example, for a vertical alignment (VA) panel, an ACOM voltage is a common voltage connected to lower plates of all subpixel storage capacitors on an array side. In some embodiments, the drive signal may alternatively include a shared common (SVCM) voltage signal. For example, for a VA panel, an SVCM voltage is a common voltage connected to a lower plate of a shared capacitor in a sub-region of each subpixel.

As shown in FIG. 1, the drive circuit 130 is connected to the display panel 140 through a plurality of row lines RL1 to RLm (which are individually or uniformly referred to as row lines RL) and a plurality of column lines CL1 to CLn (which are individually or uniformly referred to as column lines CL), where m and n are positive integers. For example, the display panel 140 includes a pixel array including a plurality of pixel units P11 to Pmn (which are individually or uniformly referred to as pixel units P). In some embodiments, each pixel unit P may include a plurality of subpixels. In FIG. 1, a pixel unit Pm2 is used as an example, and it is shown, as an example, that the pixel unit Pm2 may include three subpixels Pm2-R, Pm2-G, and Pm2-B for three primary colors red, green, and blue (RGB).

It should be understood that a structure of the display panel 140 in FIG. 1 is merely an example instead of a limitation. The solution according to embodiments of this disclosure may be applied to any appropriate display panel such as an LCD panel or an organic light-emitting diode (OLED) panel. The scope of this disclosure is not limited in this aspect.

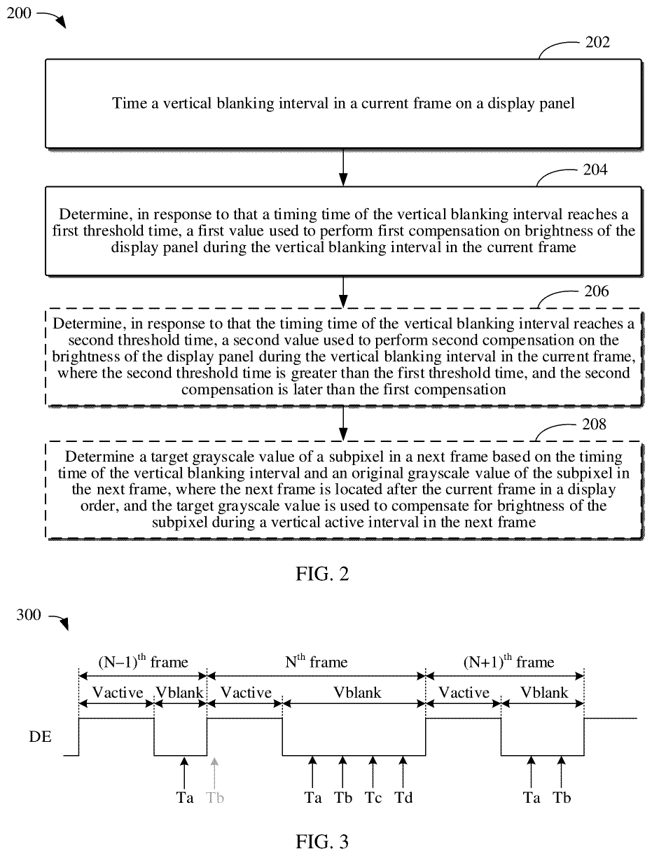

FIG. 2 is a flowchart of a method 200 for compensating for brightness of a display panel 140 according to some embodiments of this disclosure. In some embodiments, the method 200 may be performed by the electronic apparatus 120 shown in FIG. 1. It should be understood that the method 200 may further include additional blocks that are not shown and/or shown blocks may be omitted. The scope of this disclosure is not limited in this aspect.

In block 202, the electronic apparatus 120 times a vertical blanking interval in a current frame on the display panel 140. In some embodiments, the electronic apparatus 120 may time the vertical blanking interval by timing a display control signal used for the display panel 140. The display control signal includes but is not limited to a horizontal synchronization (HSYNC) signal, a vertical synchronization (VSYNC) signal, or a data enable (DE) signal.

FIG. 3 is an example timing diagram 300 for compensating for brightness of a display panel 140 according to some embodiments of this disclosure. In the embodiment shown in FIG. 3, the vertical blanking interval is timed by timing the DE signal. For example, a high level of the DE signal corresponds to a vertical active interval Vactive in the frame, and a low level of the DE signal corresponds to the vertical blanking interval Vblank in the frame. In this embodiment, the electronic apparatus 120 may start timing from each falling edge of the DE signal until there is a next rising edge, and duration of the low level corresponds to duration of the corresponding vertical blanking interval Vblank.

As described above, when a VRR technology is applied, for an (N−1)^{th} frame, an N^{th} frame, and an (N+1)^{th} frame shown in FIG. 3, duration of vertical active intervals Vactive in all the frames is the same, and duration of vertical blanking intervals Vblank in all the frames may be different. For example, duration of a vertical blanking interval Vblank in the N^{th} frame is greater than duration of a vertical blanking interval Vblank in the (N−1)^{th} frame. Therefore, a refresh rate of the N^{th} frame is less than a refresh rate of the (N−1)^{th} frame.

For ease of description, the following describes the solution in embodiments of this disclosure with reference to FIG. 3. It should be understood that the vertical blanking interval Vblank in the current frame may alternatively be timed in any other appropriate manner. For example, the vertical blanking interval Vblank may alternatively be timed in a row count detection manner. The scope of this disclosure is not limited in this aspect.

In block 204, the electronic apparatus 120 determines, in response to that a timing time of the vertical blanking interval Vblank reaches a first threshold time, a first value used to perform first compensation on brightness of the display panel 140 during the vertical blanking interval Vblank in the current frame. With reference to FIG. 3, it is assumed that the N^{th} frame corresponds to the current frame, and a moment Ta corresponds to the first threshold time. In response to that the timing time of the vertical blanking interval Vblank reaches the moment Ta, the electronic apparatus 120 may determine an analog compensation value as the first value by using the first threshold time, where the analog compensation value is used to compensate for the brightness of the display panel 140 when the duration of the vertical blanking interval Vblank is equal to the first threshold time. It should be noted that because compensation effect of adjusting a gamma voltage takes effect only in a vertical active interval Vactive in a next frame, in the solution according to embodiments of this disclosure, the brightness of the display panel 140 during the vertical blanking interval Vblank in the current frame needs to be compensated for by adjusting an analog signal, for example, an ACOM voltage signal or an SVCM voltage signal, that can be used to compensate for current leakage in real time during the vertical blanking interval Vblank in the current frame. In the context of this disclosure, such brightness compensation performed by using the analog signal is also referred to as “analog compensation”.

In some embodiments, a plurality of threshold times, that is, a plurality of moments Ta to Td in FIG. 3, may be predetermined. Brightness corresponding to a maximum refresh rate of the display panel 140 may be used as a reference, and then analog compensation values corresponding to all the threshold times are sequentially determined. For example, it is assumed that the maximum refresh rate of the display panel 140 is 164 Hz, and refresh rates corresponding to the moments Ta to Td are respectively 122 Hz, 97 Hz, 80 Hz, and 68 Hz. In an example, an analog compensation value that is used for the ACOM voltage signal and that is used for the refresh rate 122 Hz may be determined through experimental debugging performed in advance, so that when the refresh rate is switched between 164 Hz and 122 Hz, a displayed picture does not have a brightness change or flicker. Similarly, analog compensation values respectively used for the refresh rates 97 Hz, 80 Hz, and 68 Hz may be predetermined, so that when the refresh rate is switched between 164 Hz and the corresponding refresh rate, a displayed picture does not have a brightness change or flicker. The determined analog compensation value and the corresponding refresh rate may be stored in a lookup table. The lookup table may also be referred to as an analog compensation table.

Table 1 below is an example analog compensation table for the ACOM voltage signal.

TABLE 1
Example analog compensation table

| | |
|---|---|
| Refresh rate | ACOM voltage compensation value |

| | | |
|---|---|---|
| 164 | Hz | 0 |
| 122 | Hz | −16 |
| 97 | Hz | −24 |
| 80 | Hz | −34 |
| 68 | Hz | −40 |

A plurality of refresh rates corresponding to the plurality of predetermined threshold times are shown in the first column, and ACOM voltage compensation values for the corresponding refresh rates are shown in the second column. It should be understood that the values shown in Table 1 are merely examples. The scope of this disclosure is not limited in this aspect.

For example, when the timing reaches the moment Ta, the electronic apparatus 120 may obtain the analog compensation value −16 for the refresh rate 122 Hz corresponding to the moment Ta from the analog compensation table, and deliver the analog compensation value as the first value to a drive circuit 130 connected downstream to the electronic apparatus 120, to generate a corresponding ACOM voltage to compensate for current leakage, so as to compensate for the brightness of the display panel 140 in a timely manner during the vertical blanking interval Vblank. In this manner, there is no delay between brightness compensation of the display panel 140 and current leakage, to fundamentally resolve picture flickering. It should be understood that a plurality of analog signals may be simultaneously used to compensate for the brightness of the display panel 140. The scope of this disclosure is not limited in this aspect.

It should be noted that in the embodiment shown in FIG. 3, the moments Ta to Td corresponding to the plurality of threshold times are evenly distributed in terms of time, that is, there is an equal time interval between two adjacent moments. There is a linear relationship between a current leakage amount of a pixel capacitor and time. Therefore, current leakage may be more properly compensated for based on the configuration indicating even distribution in terms of time, to ensure that a displayed picture does not flicker. It should be understood that the threshold time may alternatively be determined in any other appropriate manner. For example, the plurality of threshold times may alternatively be evenly distributed in terms of a refresh rate. The scope of this disclosure is not limited in this aspect.

It should be noted that in addition to the lookup table, a correspondence between the threshold time and the corresponding analog compensation value may alternatively be stored and indicated in any other appropriate manner, for example, according to a fitting formula. The scope of this disclosure is not limited in this aspect.

In block 206, the electronic apparatus 120 determines, in response to that the timing time of the vertical blanking interval Vblank reaches a second threshold time, a second value used to perform second compensation on the brightness of the display panel 140 during the vertical blanking interval Vblank in the current frame, where the second threshold time is greater than the first threshold time, and the second compensation is later than the first compensation. With reference to FIG. 3, if the moment Tb corresponds to the second threshold time, in response to that the timing time of the vertical blanking interval Vblank reaches the moment Tb, the electronic apparatus 120 may determine an analog compensation value as the second value by using the second threshold time in a manner similar to the manner described above with reference to the first threshold time. Details are not described herein in this disclosure. In this manner, the electronic apparatus 120 may compensate for the brightness of the display panel 140 during the vertical blanking interval Vblank in a segment-based compensation manner, so that a brightness variation is further reduced, to ensure that the brightness variation is less than a threshold at which a flicker can be observed by human eyes.

In some embodiments, when the current frame corresponds to the N^{th} frame, the electronic apparatus 120 may further respectively determine, in a manner similar to the foregoing manner when the timing time reaches other predetermined moments (for example, a moment Tc and a moment Td) later than the moment Tb, a third value and a fourth value used to perform third compensation and fourth compensation on the brightness of the display panel 140 during the vertical blanking interval Vblank in the current frame.

In some embodiments, block 206 may be omitted. That is, compensation is performed only once for each vertical blanking interval Vblank. For example, compensation is performed only when the timing time reaches the moment Ta, and no compensation is performed at another moment. In this manner, an operation amount and bandwidth occupation of the electronic apparatus 120 may be reduced.

In block 208, the electronic apparatus 120 determines a target grayscale value of a subpixel in a next frame based on the timing time of the vertical blanking interval Vblank and an original grayscale value of the subpixel in the next frame, where the next frame is located after the current frame in a display order, and the target grayscale value is used to compensate for brightness of the subpixel during a vertical active interval Vactive in the next frame. For example, when the current frame corresponds to the (N−1)^{th} frame, both the N^{th} frame and the (N+1)^{th} frame are located after the current frame in the display order. Therefore, both the N^{th} frame and the (N+1)^{th} frame may be used as next frames. In the context of this disclosure, such brightness compensation performed based on the grayscale value is also referred to as “digital compensation”.

The inventor finds, through research, that when the brightness of the entire display panel 140 is compensated for by using an analog voltage such as an ACOM voltage or an SVCM voltage after the timing time of the vertical blanking interval Vblank reaches the threshold time, at a compensation moment, current leakage times of pixel capacitors located in different rows of the display panel 140 are slightly different. For example, in a vertical direction, a current leakage time of a pixel capacitor located in a last row of the display panel 140 is shorter than a current leakage time of a pixel capacitor located in a first row of the display panel 140. Therefore, compensation effect of the analog voltage for brightness in different regions on the display panel 140 is inconsistent. In this case, regional compensation may be performed on the brightness for different locations on the display panel 140 in digital compensation. In the following, a first subpixel of a first pixel unit included on the display panel 140 is used as an example for description.

In some embodiments, the electronic apparatus 120 may obtain a scaling factor for an original grayscale value of the first subpixel based on a location of the first subpixel on the display panel 140. For example, the display panel 140 may be divided into K sub-regions in the vertical direction in advance, where K may be any positive integer. Then, a scaling factor for a grayscale value of a subpixel in each sub-region is predetermined through experimental debugging or calculation. The electronic apparatus 120 may determine, based on the location of the first subpixel on the display panel 140, a sub-region in which the first subpixel is located, to obtain the scaling factor for the original grayscale value of the first subpixel. Then, the electronic apparatus 120 may scale the original grayscale value based on the scaling factor, to determine a target grayscale value for the first subpixel. In this manner, a difference between different locations on the display panel 140 may be considered in brightness compensation during the vertical active interval Vactive in the next frame, so that a brightness difference between different regions on the display panel 140 may be more precisely compensated for based on analog compensation.

In some embodiments, the next frame closely follows the current frame in the display order. For example, in FIG. 3, the N^{th} frame closely follows the (N−1)^{th} frame in the display order. In this case, it needs to be ensured that the electronic apparatus 120 can determine, before the vertical active interval Vactive in the next frame arrives, the target grayscale value used to compensate for the brightness of the subpixel during the vertical active interval Vactive in the next frame, to avoid a delay in digital compensation as much as possible. In the following, it is assumed that the current frame corresponds to the (N−1)^{th} frame, the next frame corresponds to the N^{th} frame, and the first subpixel of the first pixel unit included on the display panel 140 is used as an example for description.

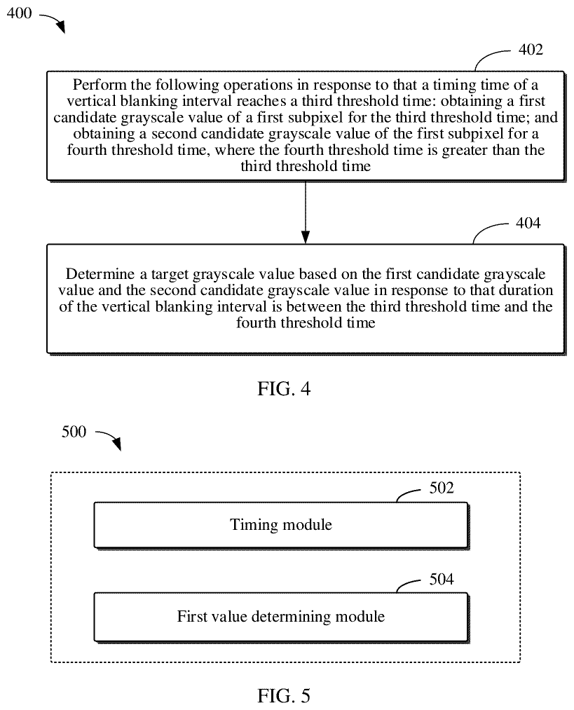

FIG. 4 is a flowchart of a method 400 for determining a target grayscale value according to some embodiments of this disclosure. For example, the method 400 may be implemented as an example of block 208 shown in FIG. 2. In some embodiments, the method 400 may be performed by the electronic apparatus 120 shown in FIG. 1. It should be understood that the method 400 may further include additional blocks that are not shown and/or shown blocks may be omitted. The scope of this disclosure is not limited in this aspect.

In block 402, the electronic apparatus 120 performs the following operations in response to that a timing time of a vertical blanking interval Vblank reaches a third threshold time: obtaining a first candidate grayscale value of a first subpixel for the third threshold time; and obtaining a second candidate grayscale value of the first subpixel for a fourth threshold time, where the fourth threshold time is greater than the third threshold time. It should be noted that in the context of this disclosure, the terms “first threshold time”, “second threshold time”, “third threshold time”, and “fourth threshold time” do not indicate an order of the threshold times. The scope of this disclosure is not limited in this aspect. For example, the third threshold time may be greater than the first threshold time, may be less than the first threshold time, or may be equal to the first threshold time.

With reference to FIG. 3, it is assumed that the third threshold time corresponds to the moment Ta, and the fourth threshold time corresponds to the moment Tb. In this case, the third threshold time is equal to the first threshold time, and the fourth threshold time is equal to the second threshold time. It should be understood that the predetermined threshold time used for digital compensation may alternatively be different from the predetermined threshold time used for analog compensation. The scope of this disclosure is not limited in this aspect.

In some embodiments, the electronic apparatus 120 may determine a compensation grayscale value as the first candidate grayscale value based on the third threshold time and an original grayscale value, where the compensation grayscale value is used to compensate for the original grayscale value when duration is equal to the third threshold time. For example, a plurality of threshold times, that is, a plurality of moments Ta to Td in FIG. 3, may be predetermined. Brightness corresponding to a maximum refresh rate of a display panel 140 may be used as a reference, and then compensation grayscale values that correspond to all grayscale values and that are used for all the threshold times are sequentially determined. For example, it is assumed that the maximum refresh rate of the display panel 140 is 164 Hz, and refresh rates of the display panel 140 corresponding to the moments Ta to Td are respectively 122 Hz, 97 Hz, 80 Hz, and 68 Hz. For example, a compensation grayscale value that is used for each grayscale value in grayscale values 0 to 255 and that is used for the refresh rate 122 Hz may be determined through experimental debugging performed in advance, so that when the refresh rate is switched between 164 Hz and 122 Hz, a displayed picture does not have a brightness change or flicker. Similarly, compensation grayscale values that correspond to grayscale values and that are used for the refresh rates 97 Hz, 80 Hz, and 68 Hz may be predetermined, so that when the refresh rate is switched between 164 Hz and the corresponding refresh rate, a displayed picture does not have a brightness change or flicker. The determined compensation grayscale value, the corresponding original grayscale value, and the corresponding moment may be stored in a lookup table similar to Table 1, and the lookup table may also be referred to as an RGB table. For example, when the timing reaches the moment Ta, the electronic apparatus 120 may read a corresponding compensation grayscale value from the RGB table based on the original grayscale value of the first subpixel in a next frame. In this manner, a compensation grayscale value that is used to compensate for the original grayscale value and that is used for a specific threshold time may be efficiently determined.

In some embodiments, a lookup table of an original grayscale value and a compensation grayscale value for a specific moment (for example, the moment Ta) may be used as a reference lookup table, an offset value between a compensation grayscale value for the same original grayscale value at another moment and the compensation grayscale value at the moment Ta is determined, and the offset value is stored as an offset lookup table. For example, when the timing reaches the moment Tb, the electronic apparatus 120 may determine a reference compensation grayscale value used for the original grayscale value at the moment Ta from the reference lookup table based on the original grayscale value of the first subpixel in the next frame, and determine an offset value for the original grayscale value from the offset lookup table, to determine, based on the reference compensation grayscale value and the offset value, a compensation grayscale value used for the original grayscale value at the moment Tb. In this manner, occupation of a storage capacity of a memory may be reduced.

The inventor finds, through research, that for a display panel 140 that includes subpixels with a positive polarity and a negative polarity, current leakage amounts of pixel capacitors of subpixels with different polarities may be slightly different. Because an ACOM voltage and an SVCM voltage are common voltages connected to all subpixels, targeted compensation cannot be provided for the pixel capacitors of subpixels with different polarities in analog compensation. In this case, polarity compensation may be performed on brightness for subpixels with different polarities in digital compensation.

In some embodiments, a positive polarity pixel compensation table and a negative polarity pixel compensation table for different threshold times may be determined in a manner similar to the manner described above with reference to the RGB table and by additionally considering a polarity of a subpixel. The positive polarity pixel compensation table stores a compensation grayscale value used to compensate for each original grayscale value when the subpixel has a positive polarity, and the negative polarity pixel compensation table stores a compensation grayscale value used to compensate for each original grayscale value when the subpixel has a negative polarity.

The electronic apparatus 120 may obtain a polarity of the first subpixel based on a location of the first subpixel on the display panel 140; and determine a compensation grayscale value as the first candidate grayscale value based on the third threshold time, an original grayscale value, and the polarity of the first subpixel, where the compensation grayscale value is used to compensate for the original grayscale value when duration is equal to the third threshold time. For example, when the timing time of the vertical blanking interval Vblank reaches the moment Ta, the electronic apparatus 120 may determine the polarity of the first subpixel by searching a polarity template based on the location of the first subpixel. For example, the first subpixel has a positive polarity in this case. Then, the electronic apparatus 120 may obtain the compensation grayscale value used for the original grayscale value of the first subpixel from a positive polarity pixel compensation table for the moment Ta. In this manner, a polarity difference between subpixels may be considered in brightness compensation during the vertical active interval Vactive in the next frame, so that targeted compensation may be provided for pixel capacitors of subpixels with different polarities, and a brightness difference between different regions on the display panel 140 may be more precisely compensated for based on analog compensation.

In some embodiments, the electronic apparatus 120 may determine a compensation grayscale value as the second candidate grayscale value based on the fourth threshold time and the original grayscale value in a manner similar to the manner described above with reference to the first candidate grayscale value. Details are not described herein in this disclosure.

In some embodiments, in response to that the timing time of the vertical blanking interval Vblank reaches the moment Tb, the electronic apparatus 120 may obtain candidate grayscale values of the first subpixel for the moment Tb and the moment Tc, in response to that the timing time of the vertical blanking interval Vblank reaches the moment Tc, the electronic apparatus 120 may obtain candidate grayscale values of the first subpixel for the moment Tc and the moment Td, and so on, until the vertical blanking interval Vblank in a current frame ends.

In block 404, the electronic apparatus 120 determines a target grayscale value based on the first candidate grayscale value and the second candidate grayscale value in response to that the duration of the vertical blanking interval Vblank is between the third threshold time and the fourth threshold time. For ease of description, an example in which the current frame corresponds to the (N−1)^{th} frame is used. In this case, the vertical blanking interval Vblank ends between the moment Ta and the moment Tb (shown by a gray arrow in FIG. 3), that is, the duration of the vertical blanking interval Vblank is between the moment Ta and the moment Tb. Therefore, in this case, the third threshold time corresponds to the moment Ta, and the fourth threshold time corresponds to the moment Tb.

In some embodiments, the electronic apparatus 120 may perform interpolation on the first candidate grayscale value and the second candidate grayscale value, to obtain the target grayscale value corresponding to the duration. In response to that the vertical blanking interval Vblank ends between the moment Ta and the moment Tb, the electronic apparatus 120 may perform, for example, linear interpolation on the first candidate grayscale value and the second candidate grayscale value obtained in block 402, to obtain a grayscale value corresponding to an end moment of the vertical blanking interval Vblank as the target grayscale value. In this manner, the target grayscale value for a refresh rate of the current frame may be accurately obtained, to improve effect of digital compensation. For example, the electronic apparatus may deliver the determined target grayscale value to a drive circuit 130 connected downstream to the electronic apparatus 120, to generate a corresponding gamma voltage, so as to display image data for the next frame during the vertical active interval Vactive in the next frame based on a grayscale value obtained through compensation.

In addition, in the case of linear interpolation, it is advantageous to evenly distribute the plurality of time thresholds for digital compensation in terms of time. Therefore, accuracy of the target grayscale value obtained through linear interpolation may be improved, to further ensure the effect of digital compensation.

It should be noted that the electronic apparatus 120 may alternatively determine the target grayscale value in any other appropriate manner, for example, directly use the first candidate grayscale value or the second candidate grayscale value as the target grayscale value. The scope of this disclosure is not limited in this aspect.

In some embodiments, the determined target grayscale value may be further adjusted for different locations on the display panel 140 based on regional compensation described above, to more precisely compensate for a brightness difference between different regions on the display panel 140.

In the foregoing various digital compensation manners, after the duration of the vertical blanking interval Vblank is accurately determined, that is, after the refresh rate of the current frame is accurately determined, different grayscale values may be compensated for to different degrees during the vertical active interval Vactive in the next frame based on the duration, so that a brightness difference and a chrominance difference between different refresh rates may be well compensated for, to resolve a flickering problem caused by the brightness difference and the chrominance difference.

It may be learned from the foregoing descriptions provided with reference to FIG. 1 to FIG. 4 that in the solution according to embodiments of this disclosure, the vertical blanking interval in the current frame is timed, and when a predetermined threshold time is reached, a corresponding compensation value is delivered to compensate for the brightness of the display panel in a timely manner during the vertical blanking interval in the current frame. Compared with a conventional known solution, in the solution according to this disclosure, a brightness change caused by current leakage can be compensated for by adjusting a related analog voltage in a timely manner. Therefore, there is no delay between brightness compensation and current leakage, to fundamentally resolve picture flickering and improve user experience of the display panel.

Example implementations of the method according to this disclosure are described in detail above with reference to FIG. 1 to FIG. 4. An implementation of a corresponding apparatus is described below.

FIG. 5 is a block diagram of an example apparatus 500 for compensating for brightness of a display panel according to some embodiments of this disclosure. The apparatus 500 may be, for example, configured to implement the electronic apparatus shown in FIG. 1. As shown in FIG. 5, the apparatus 500 may include a timing module. The timing module is configured to time a vertical blanking interval in a current frame on the display panel. In addition, the apparatus 500 may further include a first value determining module. The first value determining module is configured to determine, in response to that a timing time of the vertical blanking interval reaches a first threshold time, a first value used to perform first compensation on brightness of the display panel during the vertical blanking interval in the current frame.

In some embodiments, the apparatus may further include a second value determining module. The second value determining module is configured to determine, in response to that the timing time of the vertical blanking interval reaches a second threshold time, a second value used to perform second compensation on the brightness of the display panel during the vertical blanking interval in the current frame, where the second threshold time is greater than the first threshold time, and the second compensation is later than the first compensation.

In some embodiments, the display panel includes a first subpixel of a first pixel unit, and the apparatus may further include a target grayscale value determining module. The target grayscale value determining module is configured to determine a target grayscale value of the first subpixel in a next frame based on the timing time of the vertical blanking interval and an original grayscale value of the first subpixel in the next frame, where the next frame is located after the current frame in a display order, and the target grayscale value is used to compensate for brightness of the first subpixel during a vertical active interval in the next frame.

In some embodiments, the next frame closely follows the current frame in the display order, and the target grayscale value determining module is further configured to perform the following operations in response to that the timing time of the vertical blanking interval reaches a third threshold time: obtaining a first candidate grayscale value of the first subpixel for the third threshold time; and obtaining a second candidate grayscale value of the first subpixel for a fourth threshold time, where the fourth threshold time is greater than the third threshold time. The target grayscale value determining module is further configured to determine the target grayscale value based on the first candidate grayscale value and the second candidate grayscale value in response to that duration of the vertical blanking interval is between the third threshold time and the fourth threshold time.

The modules and/or units included in the apparatus may be implemented in various manners, including software, hardware, firmware, or any combination thereof. In some embodiments, one or more modules may be implemented through software and/or firmware, for example, machine-executable instructions stored in a storage medium. In addition to the machine-executable instructions or as an alternative, some or all of the units in the apparatus may be at least partially implemented by one or more hardware logic components. In an example instead of a limitation, example types of hardware logic components that may be used include a field programmable gate array (FPGA), an application-specific integrated circuit (ASIC), an application-specific standard part (ASSP), a system on chip (SoC), a complex programmable logic device (CPLD), and the like.

Some or all of the modules and/or units shown in FIG. 5 may be implemented as hardware modules, software modules, firmware modules, or any combination thereof. Particularly, in some embodiments, the procedure, method, or process described above may be implemented by a storage system, a host corresponding to a storage system, or hardware in another computing device independent of a storage system.

In addition, although operations are described in a particular order, it should be understood as that it is required that the operations are performed in the shown particular order or in sequence, or it is required that all the operations shown in the figures need to be performed to achieve an expected result. In a specific environment, multi-task and parallel processing may be advantageous. Similarly, although several specific implementation details are included in the foregoing descriptions, these should not be construed as limiting the scope of this disclosure. Some features described in the context of an individual embodiment may alternatively be implemented in combination in a single implementation. On the contrary, various features described in the context of a single implementation may alternatively be implemented in a plurality of implementations individually or in any appropriate sub-combination.

Although the subject matter is described in a language specific to structural features and/or method logic actions, it should be understood that the subject matter defined in the appended claims is not necessarily limited to the particular features or actions described above. On the contrary, the particular features and actions described above are merely example forms for implementing the claims.

What is claimed is:

1. A method for compensating for brightness of a display panel, wherein the method comprises:
timing a vertical blanking interval in a current frame on the display panel; and
determining, in response to that a timing time of the vertical blanking interval reaches a first threshold time, a first value used to perform first compensation on brightness of the display panel during the vertical blanking interval in the current frame.

2. The method according to claim 1, wherein the method further comprises:
determining, in response to that the timing time of the vertical blanking interval reaches a second threshold time, a second value used to perform second compensation on the brightness of the display panel during the vertical blanking interval in the current frame, wherein the second threshold time is greater than the first threshold time, and the second compensation is later than the first compensation.

3. The method according to claim 1, wherein the display panel comprises a first subpixel of a first pixel unit, and the method further comprises:
determining a target grayscale value of the first subpixel in a next frame based on the timing time of the vertical blanking interval and an original grayscale value of the first subpixel in the next frame, wherein the next frame is located after the current frame in a display order, and the target grayscale value is used to compensate for brightness of the first subpixel during a vertical active interval in the next frame.

4. The method according to claim 3, wherein the next frame closely follows the current frame in the display order, and the determining the target grayscale value comprises:
performing the following operations in response to that the timing time of the vertical blanking interval reaches a third threshold time:
obtaining a first candidate grayscale value of the first subpixel for the third threshold time;
obtaining a second candidate grayscale value of the first subpixel for a fourth threshold time, wherein the fourth threshold time is greater than the third threshold time; and
determining the target grayscale value based on the first candidate grayscale value and the second candidate grayscale value in response to that duration of the vertical blanking interval is between the third threshold time and the fourth threshold time.

5. The method according to claim 4, wherein the obtaining the first candidate grayscale value comprises:
determining a compensation grayscale value as the first candidate grayscale value based on the third threshold time and the original grayscale value, wherein the compensation grayscale value is used to compensate for the original grayscale value when the duration is equal to the third threshold time.

6. The method according to claim 4, wherein the obtaining the first candidate grayscale value comprises:
obtaining a polarity of the first subpixel based on a location of the first subpixel on the display panel; and
determining a compensation grayscale value as the first candidate grayscale value based on the third threshold time, the original grayscale value, and the polarity of the first subpixel, wherein the compensation grayscale value is used to compensate for the original grayscale value when the duration is equal to the third threshold time.

7. The method according to claim 4, wherein the determining the target grayscale value based on the first candidate grayscale value and the second candidate grayscale value comprises:
performing interpolation on the first candidate grayscale value and the second candidate grayscale value, to obtain the target grayscale value corresponding to the duration.

8. The method according to claim 4, wherein the third threshold time is equal to the first threshold time, and the fourth threshold time is equal to the second threshold time.

9. The method according to claim 3, wherein the determining the target grayscale value comprises:
obtaining a scaling factor for the original grayscale value of the first subpixel based on a location of the first subpixel on the display panel; and
scaling the original grayscale value based on the scaling factor, to determine the target grayscale value.

10. The method according to claim 1, wherein the determining the first value comprises:
determining an analog compensation value as the first value by using the first threshold time, wherein the analog compensation value is used to compensate for the brightness of the display panel when the duration of the vertical blanking interval is equal to the first threshold time.

11. The method according to claim 1, wherein the timing the vertical blanking interval comprises:
timing a display control signal used for the display panel.

12. The method according to claim 11, wherein the display control signal comprises at least one of the following: a horizontal synchronization HSYNC signal, a vertical synchronization VSYNC signal, or a data enable DE signal.

13. An electronic apparatus, wherein the electronic apparatus comprises:
a timing module, configured to time a vertical blanking interval in a current frame on a display panel; and
a first value determining module, configured to determine, in response to that a timing time of the vertical blanking interval reaches a first threshold time, a first value used to perform first compensation on brightness of the display panel during the vertical blanking interval in the current frame.

14. The electronic apparatus according to claim 13, wherein the electronic apparatus further comprises:
a second value determining module, configured to determine, in response to that the timing time of the vertical blanking interval reaches a second threshold time, a second value used to perform second compensation on the brightness of the display panel during the vertical blanking interval in the current frame, wherein the second threshold time is greater than the first threshold time, and the second compensation is later than the first compensation.

15. The electronic apparatus according to claim 13, wherein the display panel comprises a first subpixel of a first pixel unit, and the electronic apparatus further comprises:
a target grayscale value determining module, configured to determine a target grayscale value of the first subpixel in a next frame based on the timing time of the vertical blanking interval and an original grayscale value of the first subpixel in the next frame, wherein the next frame is located after the current frame in a display order, and the target grayscale value is used to compensate for brightness of the first subpixel during a vertical active interval in the next frame.

16. The electronic apparatus according to claim 15, wherein the next frame closely follows the current frame in the display order, and the target grayscale value determining module is further configured to:
perform the following operations in response to that the timing time of the vertical blanking interval reaches a third threshold time:
obtaining a first candidate grayscale value of the first subpixel for the third threshold time;
obtaining a second candidate grayscale value of the first subpixel for a fourth threshold time, wherein the fourth threshold time is greater than the third threshold time; and
determining the target grayscale value based on the first candidate grayscale value and the second candidate grayscale value in response to that duration of the vertical blanking interval is between the third threshold time and the fourth threshold time.

17. An electronic device, wherein the electronic device comprises:
the electronic apparatus according to claim 13, and
a drive circuit, configured to: receive the first value, and apply a drive signal to the display panel based on the first value.

18. The electronic device according to claim 17, wherein the drive signal comprises at least one of the following: an array common ACOM voltage signal or a shared common SVCM voltage signal.
